(19) United States
(12) Patent Application Publication
(10) Pub. No.: US 2009/0071776 A1
(43) Pub. Date: Mar. 19, 2009

(54) Bi-state solenoid with integral rebound cut-off

(76) Inventor: Stephen Carey Hagwood, Dayton, OH (US)

Correspondence Address: DELPHI TECHNOLOGIES, INC., M/C 480-410-202, PO BOX 5052, TROY, MI, 48007, US

(21) Appl. No.: 11/900,823

(22) Filed: Sep. 13, 2007

(51) Int. Cl. F16F 9/34; F16F 9/50

(52) U.S. Cl. 188/282.2

(57) ABSTRACT

A hydraulic damper including a housing, a piston assembly slideably received within the housing to define a piston chamber and a rod chamber, the piston assembly including a valve and a solenoid, the solenoid including an integral piston, wherein the valve is actuateable by the solenoid, and a cup disposed in the rod chamber, the cup being generally sealingly engageable by the integral piston.

### BACKGROUND

The present application is directed to damping apparatus and, more particularly, to damping apparatus including a bi-state solenoid and, still more particularly, to bi-state solenoids with an integral rebound cut-off.

Hydraulic dampers may be used in various dynamic systems, such as vehicle suspension systems and the like, to absorb and/or control various physical inputs. Hydraulic dampers typically include a tube (or housing) and a piston assembly. The piston assembly may be slideably received within the tube and the tube may be filled with a fluid, such as a gas charged hydraulic fluid. The piston assembly may be attached to a piston rod that extends outside the tube through a piston rod guide.

The piston assembly may include a solenoid valve that controls the flow of fluid across the piston assembly between a piston assembly chamber and a piston rod chamber. Fluid within the tube may be appropriately displaced as the piston assembly moves axially through the tube, thereby dampening the compression and rebound strokes applied to the hydraulic damper by the piston rod. The amount of damping force created by the hydraulic damper may be manipulated by actuating the solenoid valve in the piston assembly.

During a large rebound stroke, the piston rod may urge the piston assembly through the length of the tube. To avoid damage to the hydraulic damper as a result of over extension during a full rebound stroke, hydraulic dampers have been provided with various rebound cut-off means that cushion, slow and/or stop the piston assembly relative to the tube after reaching a certain point in the rebound stroke. An example of such a prior art rebound cut-off means includes the use of a spring, a piston having a check valve (or valves) and a retainer, wherein the spring, piston and retainer are disposed in the piston rod chamber and are adapted to engage a cup and trap fluid between the piston assembly and the end of the tube. While such prior art rebound cut-off means may be useful, they typically require additional components and, therefore, complicate the manufacturing and assembly processes and increase costs.

Accordingly, there is a need for a new and improved means for rebound cut-off. In particular, there is a need for a bi-state solenoid having an integral rebound cut-off.

### SUMMARY

In one aspect, a hydraulic damper may include a housing, a piston assembly slideably received within the housing to define a piston chamber and a rod chamber, the piston assembly including a valve and a solenoid, the solenoid including an integral piston, wherein the valve is actuateable by the solenoid, and a cup disposed in the rod chamber, the cup being generally sealingly engageable by the integral piston.

In another aspect, a hydraulic damper may include a housing, a piston assembly slideably received within the housing to define a piston chamber and a rod chamber, the piston assembly including a valve and a solenoid, the solenoid defining an outer surface, wherein the valve is actuateable by the solenoid, and a cup disposed in the rod chamber, the cup defining an inner surface, wherein the outer surface of the solenoid is adapted to closely and generally sealingly engage the inner surface of the cup to form a chamber between the cup and the solenoid.

In another aspect, a hydraulic damper may include a cup and a piston assembly being moveable relative to the cup, the piston assembly including a valve and a solenoid, the solenoid including an integral piston that is generally sealingly engageable with the cup to form a chamber between the cup and the solenoid.

In another aspect, a hydraulic damper may include a cup and a piston assembly that is moveable relative to the cup, the piston assembly including an integral piston that is closely and generally sealingly engageable with the cup to form a chamber between the cup and the integral piston. The chamber between the cup and the integral piston may provide a rebound cut-off function when a hydraulic fluid is trapped therein.

Other aspects of the disclosed bi-state solenoid with integral rebound cut-off and associated hydraulic dampers will become apparent from the following description, the accompanying drawings and the appended claims.

### BRIEF DESCRIPTION OF THE DRAWINGS

FIG. 1 is a front elevational view, in section, of a hydraulic damper incorporating one aspect of the disclosed bi-state solenoid with integral rebound cut-off;

FIG. 2 is a front elevational view, in section, of the hydraulic damper of FIG. 1 undergoing a rebound stroke; and

FIG. 3 is a front elevational view, in section, of the solenoid and piston rod of the hydraulic damper of FIG. 1.

### DETAILED DESCRIPTION

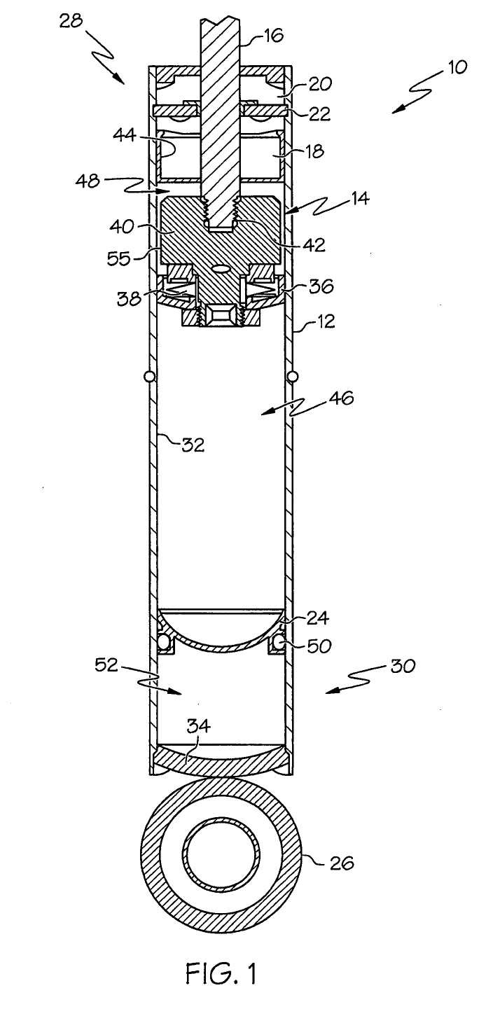

Referring to FIG. 1, a hydraulic damper 10 embodying an aspect of the disclosed bi-state solenoid with integral rebound cut-off may include a housing 12, a piston assembly 14, a piston rod 16, a cup 18, a piston rod guide 20, a seal 22, a gas cup assembly 24 and a lower mounting assembly 26. The piston rod 16 may be connected to a first body (not shown) and the lower mounting assembly 26 may be connected to a second body (not shown) such that the hydraulic damper 10 may dampen relative movement therebetween. For example, the first body may be a vehicle body or frame and the second body may be a vehicle suspension/axle or other unsprung mass.

The housing 12 may be a hollow and generally elongated body, such as a hollow cylinder or tube, and may include a proximal end 28 and a distal end 30 and may define an inner surface 32. The proximal end 28 of the housing 12 may be open and the distal end 30 of the housing 12 may be sealed by, for example, a plug 34. The lower mounting assembly 26 may be securely connected to the plug 34.

The cup 18 may be open at one end and may define an inner surface 44, wherein the inner surface 44 of the cup 18 may define a smaller inner diameter (or inner radial length, depending upon the shape of the cup 18) than the inner diameter (or inner radial length, depending upon the shape of the housing 12) defined by the inner surface 32 of the housing 12. Therefore, the cup 18 may define a step or transition from a larger inner surface (i.e., the portion of the housing 12 distal to the cup 18) to a smaller inner surface (i.e., the portion of the housing 12 overlapping with the cup 18) within the housing 12.

In one aspect, the cup 18 may be a hollow cup-shaped body, such as a hollow, shortened cylindrical body opened at one end, that has been positioned at or near the proximal end 28 of the housing 12. In another aspect, the cup 18 may be formed from and/or may be integral with the housing 12.

The piston assembly 14 may include a piston 36, a valve 38 and a solenoid 40. The piston rod 16 may be connected to the piston assembly 14 by, for example, a threaded engagement 42 with the solenoid 40.

The piston assembly 14 may be moveably received within the housing 12 such that the piston rod 16 axially extends from the piston assembly 14, through the proximal end 28 of the housing 12 and is exposed externally of the housing 12. The seal 22 (e.g., an elastomeric plug, wadding or the like) may be positioned in the region (e.g., annular region) between the piston rod 16 and the housing 12 to form a generally fluid tight seal between the piston rod 16 and the proximal end 28 of the housing 12, thereby enclosing the proximal end of the housing 12. Likewise, the piston rod guide 20 may be positioned in the region (e.g., annular region) between the piston rod 16 and the housing 12 to guide the piston rod 16 as it moves axially relative to the housing 12 during compression and rebound strokes.

The gas cup assembly 24 may include a gasket 50 and may be closely and slideably received within the housing 12 at or near the distal end 30 of the housing 12. The gasket 50 may form a gas and fluid-tight seal between the gas cup assembly 24 and the inner surface 32 of the housing 12, thereby defining a gas chamber 52 between the gas cup assembly 24 and the plug 34. The gas chamber 52 may be filled with a high pressure gas, such as air.

The piston 36 of the piston assembly 14 may closely and sealingly engage the inner surface 32 of the housing 12 to define a piston chamber 46 distal to the piston 36, between the piston assembly 14 and the gas cup assembly 24, and a rod chamber 48 proximal to the piston 36, between the piston assembly 14 and the seal 22. The piston chamber 46 and the rod chamber 48 may be filled with a gas charged hydraulic fluid.

The valve 38 may be a bi-state valve and may be actuated by the solenoid 40. In one aspect, the valve 38 may be a normally open valve and the solenoid 40 may actuate the valve 38 from an open position to a closed position. In another aspect, the valve 38 may be a normally closed valve and the solenoid 40 may actuate the valve 38 from a closed position to an open position.

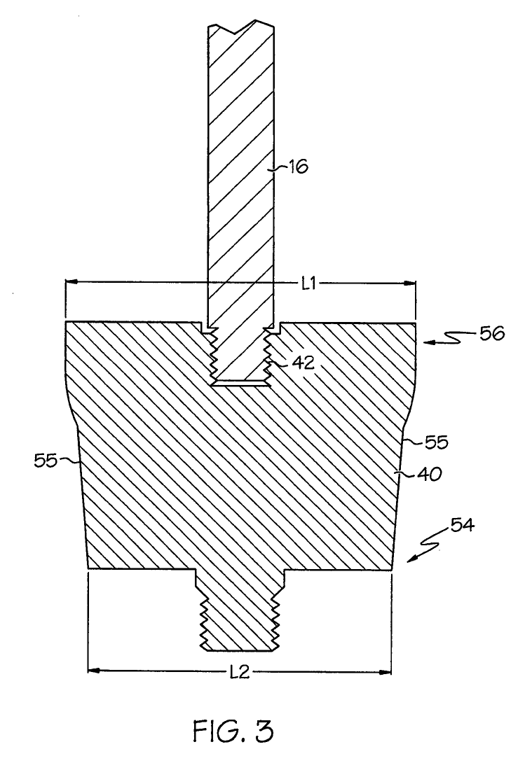

As shown in FIG. 3, the solenoid 40 may be a mass of magnetizable material and may include an outer surface 55, a distal end 54 and a proximal end 56. While the solenoid 40 is shown as having a generally cylindrical shape, those skilled in the art will appreciated that various shapes and configurations of the solenoid 40 may be used without departing from the scope of the present disclosure. The solenoid 40, or at least a portion thereof, may be sized and shaped to function as a piston, wherein the outer surface 55 of the solenoid 40, or at least a portion thereof, is adapted to closely and generally sealingly engage the inner surface 44 of the cup 18.

In one aspect, the proximal end 56 of the solenoid 40 may have a radial length L1 that is larger than the radial length L2 of the distal end 54 of the solenoid 40. The radial length referred to herein may be a diameter when the solenoid 40 is generally cylindrical in shape. In particular, the radial length L1 of the proximal end 56 of the solenoid 40 may be selected to closely and slideably engage the inner surface 44 of the cup 18 such that the proximal end 56.of the solenoid 40 acts as an integral piston adapted to engage the cup 18 to trap hydraulic fluid in the cup 18. In another aspect, the outer surface 55 of the solenoid 40 may be tapered, whether regularly or irregularly, such that at least a portion of the outer surface 55 of the solenoid 40 closely and generally sealingly engages the inner surface 44 of the cup 18. In another aspect, the entire solenoid 40 may be formed as a piston adapted to closely and generally sealingly engage the inner surface 44 of the cup 18 to trap hydraulic fluid between the cup 18 and the solenoid 40.

The solenoid 40 may be magnetized by a magnetic field and, as a result, may actuate (e.g., open or close) the valve 38 accordingly. The magnetic field may be external (e.g., a coil wrapped around the hydraulic damper 10) or internal (e.g., a coil within the solenoid). The magnetization of the solenoid 40 may be controlled by controlling the applied magnetic field, which in turn may be controlled by, for example, manipulating an electric current.

Gas charged hydraulic fluid may flow between the piston chamber 46 and the rod chamber 48 when the valve 38 is in an open configuration. In particular, when the valve 38 is in an open configuration, gas charged hydraulic fluid may flow between the piston chamber 46 and the rod chamber 48 by flowing through the piston 36 by way of the valve 38 and through the region (e.g., an annular region, depending upon the shape of the solenoid 40 and the housing 12) between the solenoid 40 and the inner surface 32 of the housing 12.

Accordingly, when the valve 38 is in an open configuration, the piston rod 16 may be easily displaced relative to the housing 12. However, when the valve 38 is in a closed configuration, fluid transfer between the piston 46 and rod 48 chambers is restricted and displacement of the piston rod 16 relative to the housing 12 is limited.

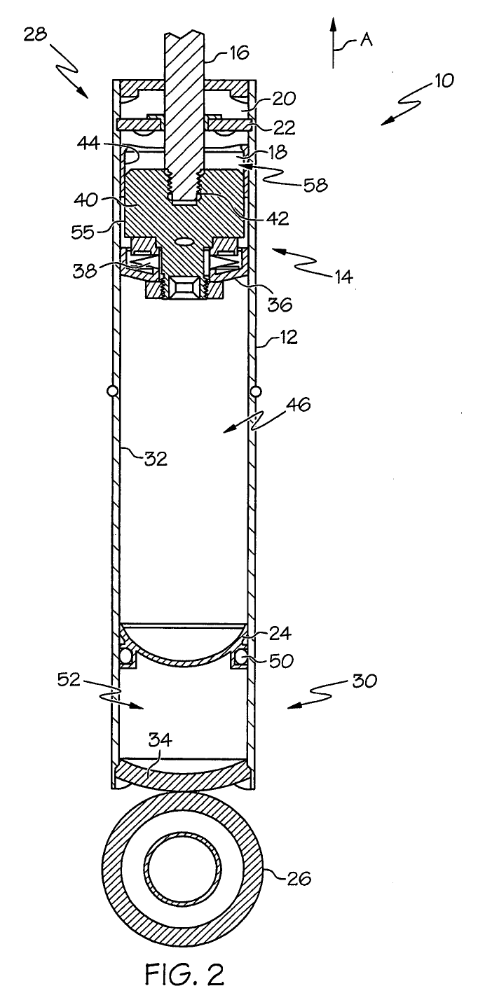

As shown in FIG. 2, during a full rebound stroke, the piston rod 16 and piston assembly 14 are drawn in the proximal direction (arrow A). At a predetermined point in the rebound stroke, the solenoid 40 is drawn into the cup 18 and the outer surface 55 of the solenoid 40, or at least a portion thereof, closely and generally sealingly engages the inner surface 44 of the cup 18 to trap gas charged hydraulic fluid between the cup 18 and the solenoid 40 in a temporarily formed rebound cut-off chamber 58. The gas charged hydraulic fluid trapped in the rebound cut-off chamber 58 may cushion, slow and/or stop the movement of the piston rod 16 as it travels in the proximal direction (arrow A) during a rebound stroke.

At this point, those skilled in the art will appreciate that rebound cut-off may be achieved by trapping gas charged hydraulic fluid in a rebound cut-off chamber 58 by forming an integral piston on the solenoid 40, wherein the integral piston on the solenoid 40 is adapted to closely and sealingly engage a cup 18 disposed in the proximal end 28 of the housing 12.

While reference has been made to an electromechanical hydraulic damper, those skilled in the art will appreciate that the disclosed integral rebound cut-off may be applied to any mono-tube damper, such as a magneto-rheological fluid damper, a standard passive damper or the like. In particular, those skilled in the art will appreciate that various mono-tube dampers may be provided with a piston assembly having an integral piston adapted to engage a cup and trap hydraulic fluid between the cup and the integral piston.

Although various aspects of the disclosed bi-state solenoid with integral rebound cut-off have been shown and described, modifications may occur to those skilled in the art upon reading the specification. The present application includes such modifications and is limited only by the scope of the claims.

What is claimed is:

1. A hydraulic damper comprising:
a housing;
a piston assembly slideably received within said housing to define a piston chamber and a rod chamber, said piston assembly including a valve and a solenoid, said solenoid including an integral piston, wherein said valve is actuateable by said solenoid; and
a cup disposed in said rod chamber, said cup being generally sealingly engageable by said integral piston.

2. The hydraulic damper of claim 1 wherein said housing is generally cylindrical.

3. The hydraulic damper of claim 1 wherein said piston chamber and said rod chamber are filled with a gas charged hydraulic fluid.

4. The hydraulic damper of claim 1 wherein said piston assembly further includes a piston assembly piston, said piston assembly piston being closely and sealingly engaged with said housing.

5. The hydraulic damper of claim 1 wherein said valve is a bi-state valve.

6. The hydraulic damper of claim 1 wherein said valve is a normally closed valve.

7. The hydraulic damper of claim 1 wherein said integral piston is sized and shaped to closely and generally sealingly engage said cup to form a chamber therebetween.

8. The hydraulic damper of claim 1 wherein said cup is a hollow body positioned in said housing.

9. The hydraulic damper of claim 1 wherein said cup is integral with said housing.

10. The hydraulic damper of claim 1 further comprising a piston rod connected to said piston assembly.

11. The hydraulic damper of claim 1 wherein said cup includes an inner surface and said integral piston includes and outer surface, said outer surface being sized and shaped to closely and generally sealingly engage said inner surface.

12. A hydraulic damper comprising:
a housing;
a piston assembly slideably received within said housing to define a piston chamber and a rod chamber, said piston assembly including a valve and a solenoid, said solenoid defining an outer surface, wherein said valve is actuateable by said solenoid; and
a cup disposed in said rod chamber, said cup defining an inner surface, wherein said outer surface of said solenoid is adapted to closely and generally sealingly engage said inner surface of said cup to form a chamber between said cup and said solenoid.

13. The hydraulic damper of claim 12 wherein said piston chamber and said rod chamber are filled with a gas charged hydraulic fluid.

14. The hydraulic damper of claim 13 wherein said gas charged hydraulic fluid is trapped in said chamber when said chamber is formed.

15. The hydraulic damper of claim 12 wherein said piston assembly further includes a piston assembly piston, said piston assembly piston being closely and sealingly engaged with said housing.

16. The hydraulic damper of claim 12 wherein said valve is a bi-state valve.

17. The hydraulic damper of claim 12 wherein said cup is a hollow body positioned in said housing.

18. The hydraulic damper of claim 12 wherein said cup is integral with said housing.

19. The hydraulic damper of claim 12 further comprising a piston rod connected to said piston assembly.

20. A hydraulic damper comprising a cup and a piston assembly that is moveable relative to said cup, said piston assembly including an integral piston that is closely and generally sealingly engageable with said cup to form a chamber between said cup and said integral piston.
